(19) United States
(12) Patent Application Publication
(10) Pub. No.: US 2008/0229375 A1
(43) Pub. Date: Sep. 18, 2008

(54) LOCALLY STORED VIDEO CONTENT HAVING A VIDEO RESOLUTION ASSOCIATED WITH REMOTE DEVICES

(76) Inventors: Eric Roberts, Duluth, GA (US); James Strothmann, Alpharetta, GA (US); William C. VerSteeg, Alpharetta, GA (US); Ajith N. Nair, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/686,398

(22) Filed: Mar. 15, 2007

(51) Int. Cl. H04N 7/173

(52) U.S. Cl. 725/100; 725/87

(57) ABSTRACT

The present invention is directed to systems and methods for forwarding locally stored video content that has a video resolution associated with receiving remote devices. More specifically, set top boxes (STBs) receive full screen and lower resolution video content for each program title. The STB may store both versions of the video content for future viewing. When remote devices request a program title, the STB forwards the lower resolution version. Alternatively, the STB may request an appropriate video resolution for a remote device from a video service provider.

### FIELD OF THE INVENTION

The present invention relates generally to a communications system. In particular, the present invention is directed to forwarding locally stored video having a suitable resolution to remote devices within the communications system.

### BACKGROUND OF THE INVENTION

In a communications system, set top boxes (STBs) are typically capable of locally storing video content received by a video service provider. More specifically, an internal hard drive allows the STB to store received video content for future viewing. Recent advances further allow the STB to forward the stored video content to remote devices, such as computers, cellular phones, play stations, etc. In order to accurately display the video content on the remote devices, however, the STB needs to transcode or perform a scaling operation on the stored video content. More specifically, the video content, which is stored as a full screen video, needs to be scaled down to a suitable resolution, which typically is 320×240 or smaller, for smaller remote device screens. Some STBs include the necessary circuitry and software to perform the transcode operation; however, it is very expensive to include this feature in the numerous STBs in a communications system. Additionally, performing a video scaling operation by the processing circuitry and software in an STB places a burden on the normal operation of the STB. Thus, there exists a need that enables an STB to forward locally stored video content having a suitable video resolution to remote devices without requiring the STB to have the expensive circuitry and software to perform the video scaling and additionally not adding computationally intensive steps.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 illustrates a communications system that transmits video content to STBs, which subsequently transcoder and forward video content to remote devices.

FIG. 2 is a block diagram of an abridged STB that is suitable for use in the communications system of FIG. 1.

FIG. 3 is a block diagram of a communications system that enables a STB to forward video content having a suitable video resolution to remote devices without having to perform the scaling operation in accordance with the present invention.

FIG. 4 is an abridged block diagram of the STB in accordance with the present invention that is suitable for use in the communications system of FIG. 3.

FIG. 5 illustrates an example database linking a program title with its associated full screen video content and lower resolution video content, which is stored in memory, in accordance with the present invention.

### DETAILED DESCRIPTION

Preferred embodiments of the invention can be understood in the context of a broadband communications system. Note, however, that the invention may be embodied in many different forms and should not be construed as limited to the embodiments set forth herein. All examples given herein, therefore, are intended to be non-limiting and are provided in order to help clarify the description of the invention.

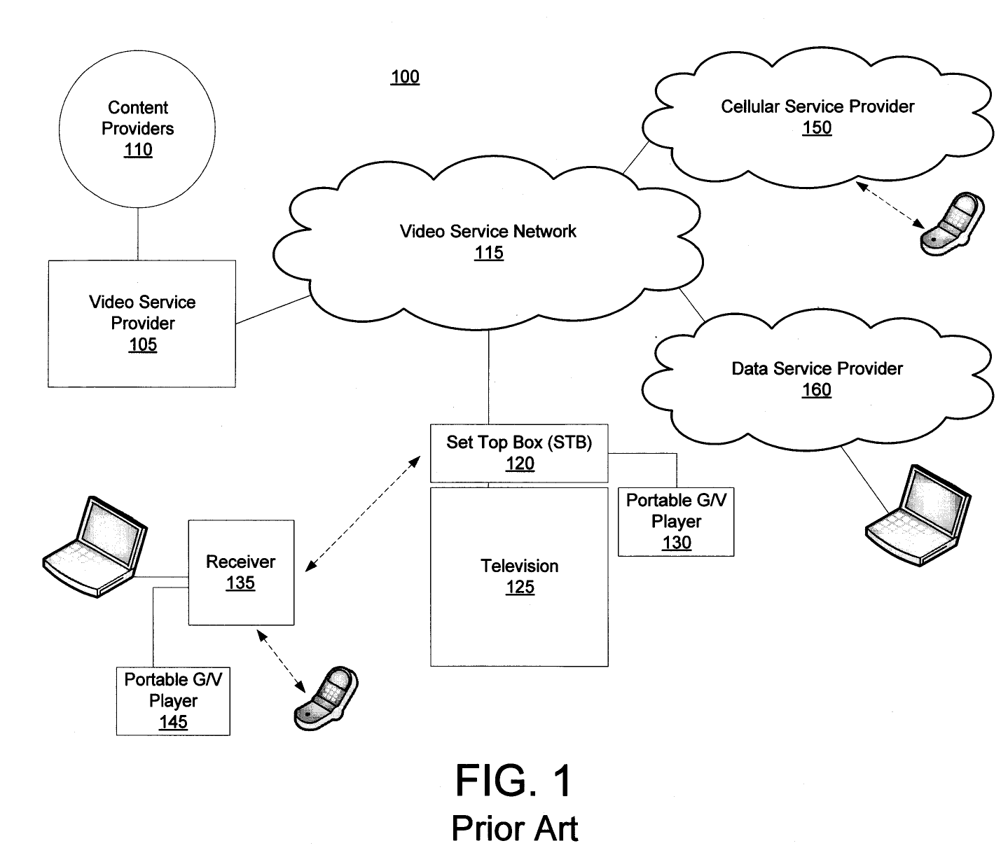

FIG. 1 illustrates a communications system 100 that transmits video content to STBs, which subsequently transcode and forward video content to remote devices. Accordingly, a video service provider 105 receives video content from content providers 110. The video service provider 105 performs the necessary operations on the received video content in order to transmit the video content to the video service network 115 for transmission to a plurality of STBs. It will be appreciated that only one STB 120 is shown for simplicity. The STB 120 may immediately forward the video content for display on a television 125 in a known manner. Additionally, the STB 120 may store the video content in an internal hard drive. Subsequently, if desired, the STB 120 may forward the stored video content to coupled remote devices. By way of example, the STB 120 may forward the stored video content to a wired remote devices, such as a portable game and/or video player 130, or the STB 120 may wirelessly forward the stored video content to a receiver 135, which then forwards the video content to coupled remote devices, such as a computer 140, a PSP 145, or a cellular telephone 150. A further method of disseminating video content from the STB's storage could involve the transfer of video content to a removable storage card, and the subscriber could place the removable storage card in a portable video player. Additional remote devices may be indirectly coupled to the STB 120 via other service providers, such as a cellular service provider 155 or a data service provider 160. In this manner, the stored video content is routed through the video service network 115 and on to the cellular service provider 155 for transmission to a cellular telephone 165 or to the data service provider 160 for transmission to a computer 170, for example.

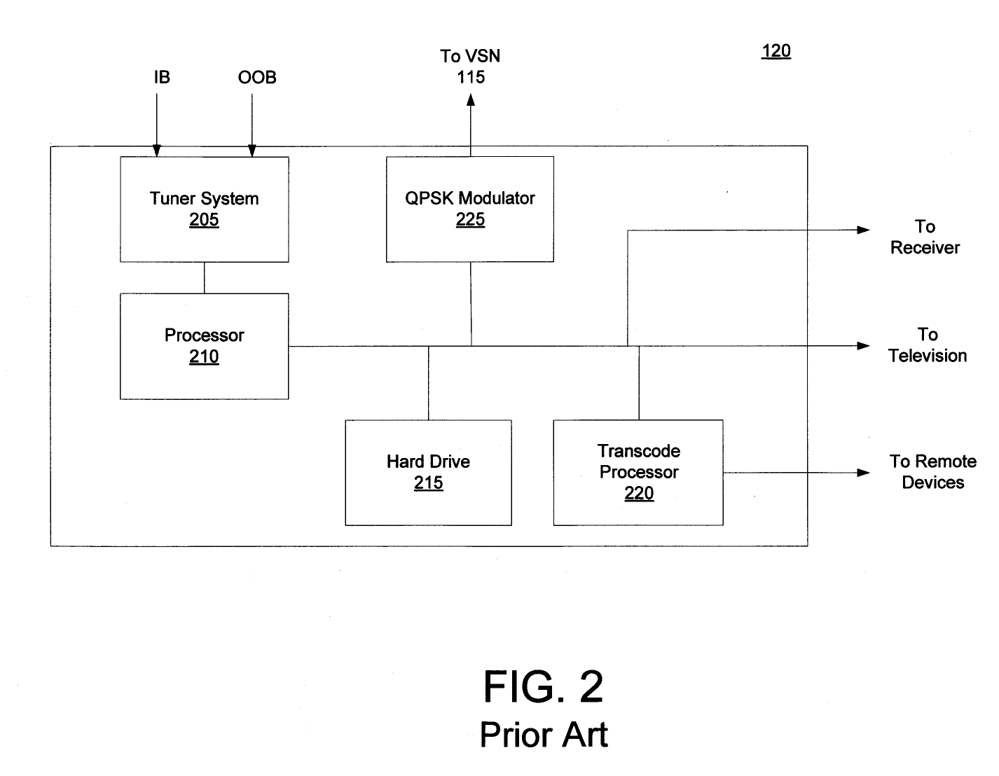

FIG. 2 is a block diagram of an abridged STB 120 that is suitable for use in the communications system 100 of FIG. 1. A tuner system 205 receives in-band (IB) and out-of-band (OOB) video content and other data signals from the video service network 115. After processing by processor 210 in a known manner, received video content may be provided to the television 125 for immediate viewing. Additionally, the video content may alternatively or concurrently be stored in a hard drive 215. As previously mentioned, when video content is transmitted to remote devices either directly (e.g., the remote devices are coupled to the STB 120) or indirectly (e.g., the remote devices are coupled to the STB 120 through the video service network 115 and/or other service providers), a transcode or scaling operation must initially be performed. Therefore, the video content is provided to a transcode processor 220, which is shown as a separate device, but may also be included within the processor 210. The transcode device 220 then scales the full size video resolution of the video content down to an appropriate resolution, which is required by the receiving remote device. The scaled video content is then either provided directly to the coupled remote devices or provided to the video service network 115 via a quadrature phase shift keying (QPSK) modulator 225. As previously mentioned, however, the transcode processor 220 is a time consuming process and also adds undesired expense to the STB 120.

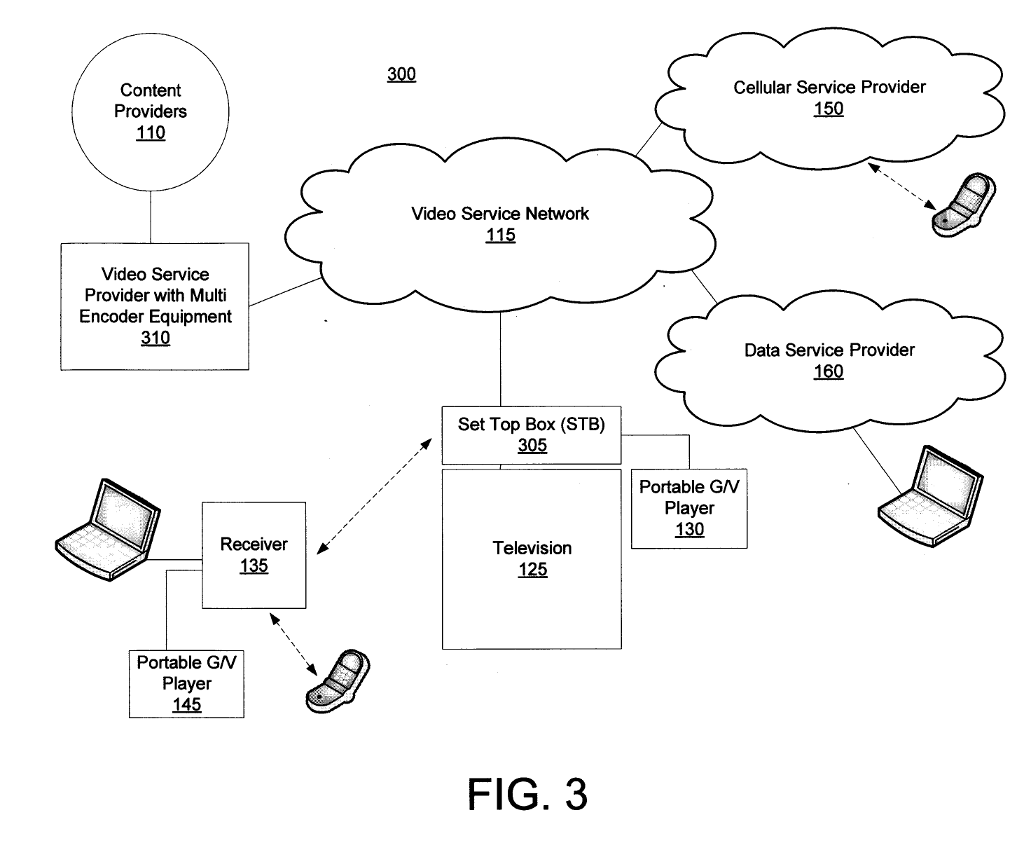

FIG. 3 is a block diagram of a communications system 300 that enables an STB 305 to forward video content having a suitable video resolution to remote devices without having to perform the scaling operation in accordance with the present invention. As mentioned, content providers 110 provide video content to the video service provider 105. Prior to transmitting the video content to the video service network 115, video equipment performs different processes on the video content, e.g., the video content is encrypted and modulated onto a radio frequency (RF) carrier for transmission to the STBs. Another process encodes the received video content via encoders. A multiencoder 310 may additionally generate other streams of the received video content. The other streams may include an MPEG-2 stream, an MPEG-4 stream, and a lower resolution of the full screen video content. In a preferred embodiment the video content is encoded by different video encoders. The lower resolution video content is used by an STB as a picture-in-picture (PIP) stream. The lower resolution stream is transmitted for the times when a viewer wishes to view a first video on a main screen along with a lower resolution, i.e., PIP, video that is shown in the corner of the main screen.

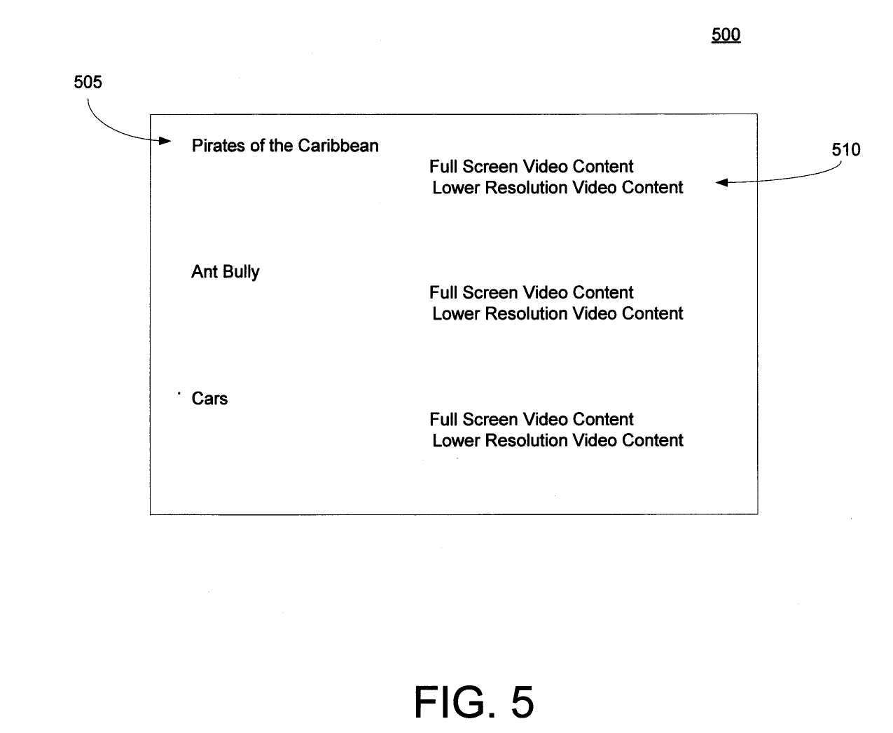

In accordance with the present invention, when an STB 305 records a full screen video, it will optionally record the lower resolution version of the full screen video. This may be a default of the STB 305 or it may be selected based on user input. The full screen video content and the lower resolution video content are associated with a video content program title as illustrated in FIG. 5 and stored in memory of the STB 305. In this manner, a subscriber can subsequently select a program title from an interface, e.g., “Pirates of the Caribbean,” which can be selected from either a STB graphical user interface (GUI) or from a remote device GUI. The appropriate video content based on the requesting device (e.g., the STB 305 or a remote device) is then retrieved from the hard drive and provided via an appropriate transfer port and is further discussed below.

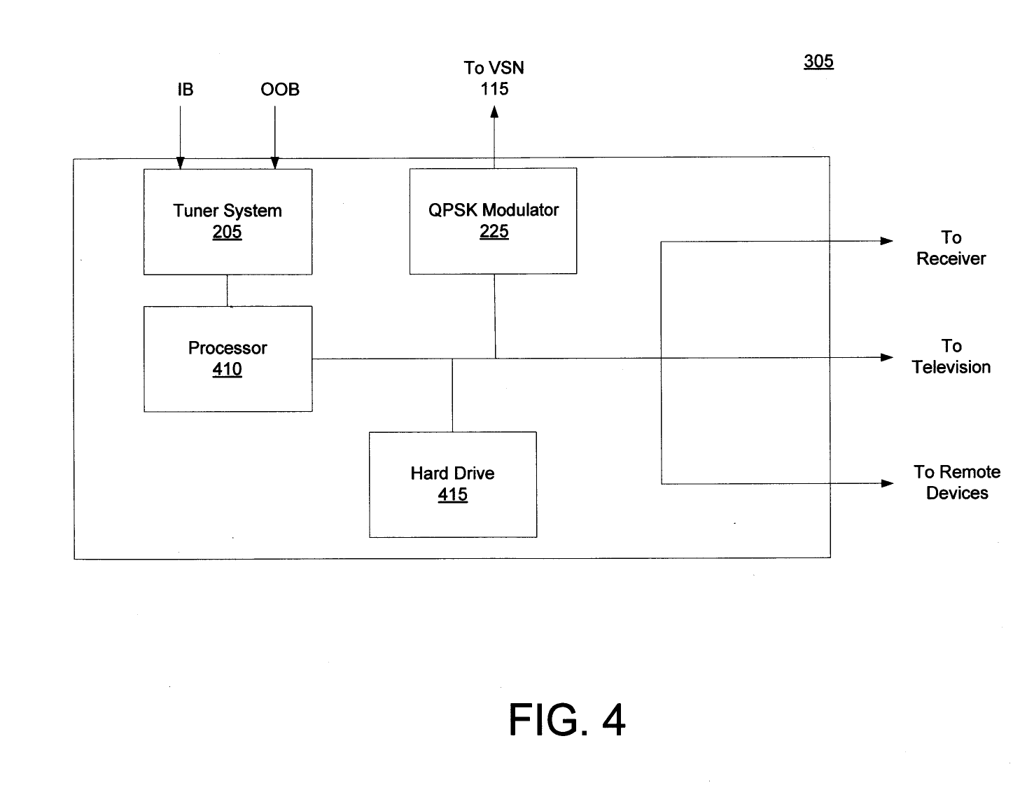

FIG. 4 is an abridged block diagram of the STB 305 in accordance with the present invention that is suitable for use in the communications system of FIG. 3. The tuner system 205 receives the full screen and the associated lower resolution video content. A processor 410 instructs a hard drive 415 to store both versions of the video content and appropriately associates the two versions having a same program title in the database 500. When a coupled remote device, such as portable game/video player 130, requests a stored program title, e.g., “Pirates of the Caribbean” 505, the processor 410 recognizes that the request was made by the portable game/video player 130 due to the request coming in to the STB 305 on the portable game/video player connecting port. Alternatively, the request may be generated at the STB 305 by proxy for the portable game/video player 130. The processor 410 then retrieves and transmits the lower resolution video content 510 to the portable game/video player 130 without performing the previously necessary scaling operation. Similarly, when wireless remote devices or remote devices coupled to the video service network 115 request a program title, the processor 410 transmits the lower resolution video content.

It will be appreciated that the STB 305 may perform a sensing operation upon boot up that detects whether remote devices are directly or wirelessly connected to the STB 305. It may then automatically save the lower screen resolution video content when saving the full screen video content. Another embodiment may require a subscriber to select that the lower resolution video content is to be saved. A further embodiment is to perform a set up procedure that uses a STB GUI to manually set up remote devices and then the STB 305 automatically stores the lower resolution video content.

Furthermore, if remote devices require a different resolution than the transmitted lower resolution video content, the STB 305 may request an appropriate video resolution for these remote devices. For example, a cellular telephone may require a lower resolution than the stored lower resolution video content. In this manner, the STB 305 may transmit a request for a different resolution of the video content. Accordingly, the multiencoder 310 rescales the video content to the requested resolution. The STB 305 may determine the video resolution in different ways. A first way may be to self-discover using an internal database that includes various remote devices and their required video resolution. Another way may be for a subscriber to manually enter the video resolution of a remote device. Importantly, however, the multiencoder 310 performs the scaling operation, and the STB 305 does not require the necessary circuitry and software.

While this invention has been described in conjunction with the specific embodiments thereof, it is evident that many alternatives, modifications and variations will be apparent to those skilled in the art. Accordingly, the preferred embodiments of the invention, as set forth herein, are intended to be illustrative and not limiting. Various changes may be made without departing from the truth and the full scope of the invention as defined by the following claims.

1. A method of forwarding locally stored video content having a video resolution to a remote device, the method comprising the steps of:
receiving at least two versions of a video content having an associated program title, wherein each of the at least two versions has a different video resolution;
storing the at least two versions in memory;
receiving a request from a remote device for the program title; and
transmitting one of the at least two versions associated with the requested program title to the remote device, wherein the transmitted version has an appropriate video resolution for the requesting remote device.

2. The method of claim 1, wherein the transmitted version is a lower resolution of the video content.

3. The method of claim 1, further comprising updating a database associated the program title with the at least two versions.

4. The method of claim 1, further comprising the steps of:
receiving a request from a television for the program title; and
transmitting one of the at least two versions associated with the program title to the television, wherein the transmitted version has an appropriate video resolution for the requesting television.

5. The method of claim 4, wherein the transmitted version is a full screen video resolution.

6. The method of claim 1, further comprising the steps of:
encoding the video content into the at least two versions; and
broadcasting the at least two versions of the video content.

7. The method of claim 6, further comprising the steps of:
receiving a request for the program title from a remote device requiring a different video resolution than the at least two versions;
transmitting a request for the different video resolution;
encoding the video content associated with the program title with the different video resolution; and
transmitting the different video resolution version.

8. The method of claim 1, further comprising the step of determining the request was received by the remote device by sensing an interface port by which the remote device is coupled.

9. The method of claim 1, further comprising the step of determining the request was received by the remote device by a selection made from a user interface.

10. A system for forwarding locally stored video content having a video resolution to a plurality of remote devices, the system comprising:
a set top box for receiving at least two versions of a video content having an associated program title, wherein each of the at least two versions has a different video resolution, and for storing in memory the at least two versions,
wherein upon request for the program title, the set top box for determining which of the at least two versions to transmit.

11. The system of claim 10, wherein the at least two versions of video content are encoded by different video encoders.

12. The system of claim 10, further comprising:
a remote device for transmitting the request for the program title, wherein the transmitted version is a lower resolution of the video content.

13. The system of claim 10, further comprising:
a television for transmitting the request for the program title, wherein the transmitted version is a full screen video resolution of the video content.

14. The system of claim 10, the system further comprising:
a multiencoder for encoding the video content into the at least two versions, and for broadcasting the at least two version of the video content to the set top box.

15. The system of claim 10, the set top box further comprising:
a database for storing the at least two versions of the video content in accordance with the program title.

16. The system of claim 14, wherein the request from a remote device for the program title requires a different video resolution than the at least two versions, wherein the set top box transmits a request to the multiencoder for the different video resolution.

17. A system for receiving and forwarding video content having a video resolution to a plurality of remote devices, the system comprising:
a multiencoder for encoding the video content into at least two video resolutions, and for broadcasting the at least two video resolutions;
a plurality of set top boxes for receiving the at least two video resolutions of the video content, and for selectively storing in memory the at least two video resolutions, wherein the at least two video resolutions have a common program title, and, upon request, a set top box transmitting a stored video content having one of the at least two video resolutions to a remote device.

18. The system of claim 17, wherein the requesting remote device requests the common program title, and wherein the set top box determines which of the at least two video resolutions to transmit.

19. The system of claim 17, wherein the at least two video resolutions include a full screen version and a lower resolution small screen version.

20. The system of claim 17, wherein each set top box selectively stores in memory that at least two video resolutions based upon coupled remote devices.

21. The system of claim 17, wherein, if the requesting remote device requires a different video resolution than the at least two video resolutions, the set top box for transmitting a request to the multiencoder for the different video resolution.

22. The system of claim 17, wherein the set top further comprises a database for storing the at least video resolutions of the video content in accordance with the program title.
